(19) United States
(12) Patent Application Publication
(10) Pub. No.: US 2011/0135291 A1
(43) Pub. Date: Jun. 9, 2011

(54) CAMERA ADJUSTING SYSTEM AND METHOD

(75) Inventors: Hou-Hsien Lee, Tu-Cheng (TW); Chang-Jung Lee, Tu-Cheng (TW); Chih-Ping Lo, Tu-Cheng (TW)

(73) Assignee: HON HAI PRECISION INDUSTRY CO., LTD., Tu-Cheng (TW)

(21) Appl. No.: 12/770,777

(22) Filed: Apr. 30, 2010

(30) Foreign Application Priority Data
Dec. 3, 2009 (CN) 200910310800.2

(51) Int. Cl. G03B 17/00

(52) U.S. Cl. 396/58

(57) ABSTRACT

A camera adjusting system includes a control headgear, a gravitational sensor, a storing unit, a processing unit, a network unit, a signal sending and receiving unit, and a drive unit. The gravitational sensor detects motions of the head of a user and sends out an electronic signal. The storing unit stores a first instruction and a second instruction. The processing unit executes the first instruction to convert the electronic signal to displacement information and executes the second instruction to convert the displacement information to a control signal to change a viewing angle and focus of a camera.

### CROSS-REFERENCE

Relevant subject matter is disclosed in one co-pending U.S. patent application (Attorney Docket No. US28715) filed on the same date and having the same title, which are assigned to the same assignee as this patent application.

### BACKGROUND

1. Technical Field

The present disclosure relates to a camera adjusting system and a camera adjusting method.

2. Description of Related Art

Pan-tilt-zoom (PTZ) cameras are commonly used in security systems and, generally, are remotely controlled through the use of computers. To aim and adjust focus may require complex commands to be entered with a keyboard of the computer which can be slow and inconvenient. Therefore, there is room for improvement in the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a block diagram of an embodiment of a camera adjusting system adjusting aim and focus of a camera, the camera adjusting system including control glasses, a drive unit, and a base.

FIG. 2 is an isometric view of the control glasses of FIG. 1.

FIG. 3 is an isometric view of the drive unit, the base, and the camera of FIG. 1.

FIGS. 4a, 4b, 4c, 4d, and 4e are schematic views showing the camera adjusting system of FIG. 1 adjusting the camera of FIG. 3.

FIG. 5 is a flowchart of an embodiment of a camera adjusting method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

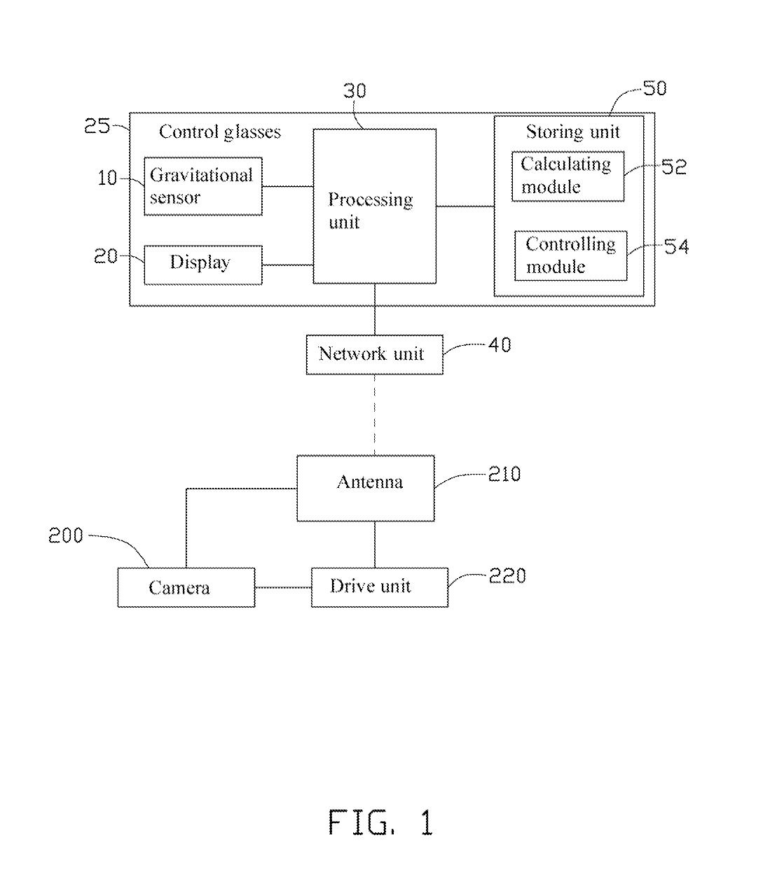

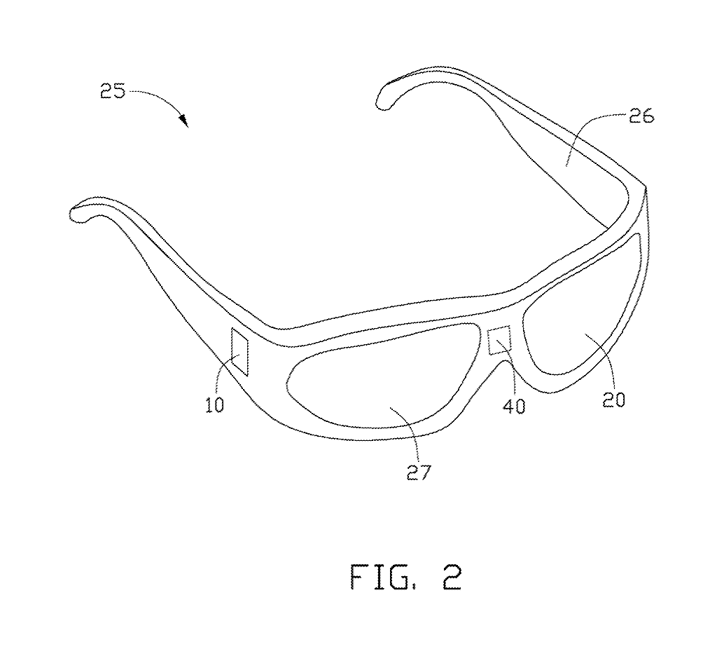

Referring to FIGS. 1 and 2, an exemplary embodiment of a camera adjusting system includes a remote control headgear, the control glasses 25 presented here as one embodiment, a gravitational sensor 10, a display 20, a processing unit 30, a network unit 40, a storing unit 50, a signal sending and receiving unit such as an antenna 210, and a drive unit 220. The camera adjusting system is used to aim and/or focus a camera 200 according to the motions of the control glasses 25 such as would occur if a user were wearing the control glasses 25.

The gravitational sensor 10 is mounted to a rim 26 of the control glasses 25 and exposed from the rim 26. The display 20 is configured as a lens and mounted in the rim 26 alongside a lens 27 of the control glasses 25. The processing unit 30, network unit 40, and storing unit 50 are mounted in the rim 26, wherein the network unit 40 is exposed from the rim 26.

The gravitational sensor 10 detects motions of the control glasses 25. The motions detected may coincide with and be interpreted as a user turning his/her head left, right, up, and down. The gravitational sensor 10 sends out an electronic signal according to the detected motions.

The display 20 displays images captured by the camera 200 to be viewed by the user of the control glasses 25. The display 20 may be a liquid crystal display or a light emitting diode display.

The processing unit 30 is connected to the gravitational sensor 10 to receive the electronic signals, and also connected to the display 20, the network unit 40, and the storing unit 50.

The network unit 40 communicates with the antenna 210 via a wired network or a wireless network.

The storing unit 50 includes a calculating module 52 and a controlling module 54. The calculating module 52 stores a first instruction to be executed by the processing unit 30, thereby the processing unit 30 converts the electronic signal of the gravitational sensor 10 to displacement information. For example, when the user turns his/her head right 45 degrees, the processing unit 30 executes the first instruction and converts the electronic signal to displacement information (+45°, 0°), wherein “+45°” represents 45 degree pivot motion to the right, and “0°” represents no tilting of the head up or down.

The controlling module 54 stores a second and additional instructions to be executed by the processing unit 30 according to received signals, thereby the processing unit 30 converts the displacement information to a control signal. For example, when the displacement information is (+45°, 0°), the processing unit 30 executes the second instruction and turns the camera 200 right 45 degrees. Other displacement values accordingly are associated with the additional instructions.

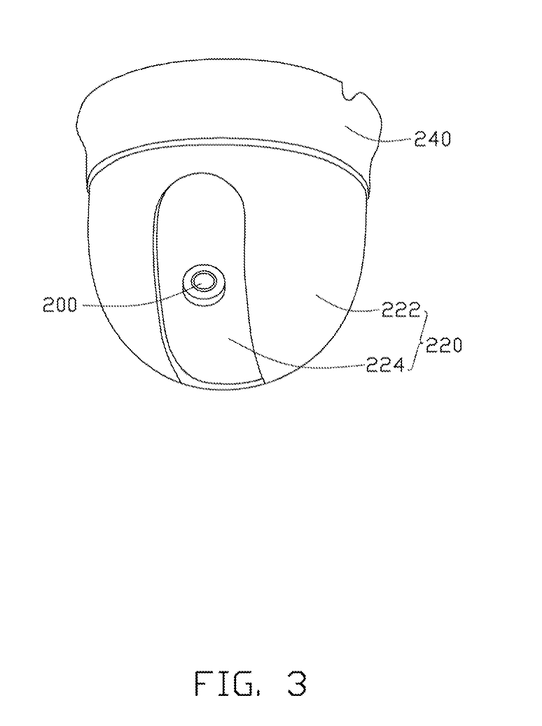

Referring to FIG. 3, the camera adjusting system further includes a base 240. The base 240 of the drive unit 220 is fixed to, for example, a ceiling. The antenna 210 is accommodated in the base 240. The drive unit 220 is connected to the antenna 210. The camera 200 is connected to the antenna 210 and the drive unit 220.

The antenna 210 sends image signals from the camera 200 to the network unit 40 and receives the control signals via the network unit 40.

The drive unit 220 changes aim of the camera 200 according to the control signals. The drive unit 220 includes a first rotating driver 222 rotatably mounted to the base 240 and a second rotating driver 224 rotatably mounted to the first rotating driver 222. The camera 200 is mounted to the second rotating driver 224. The first rotating driver 222 rotates around a vertical axis and the second rotating driver 224 rotates around a horizontal axis perpendicular to the vertical axis. For example, when the control signal is for turning the camera 200 right 45 degrees, just the first rotating driver 222 responds by rotating around the vertical axis to turn the camera 200 right 45 degrees.

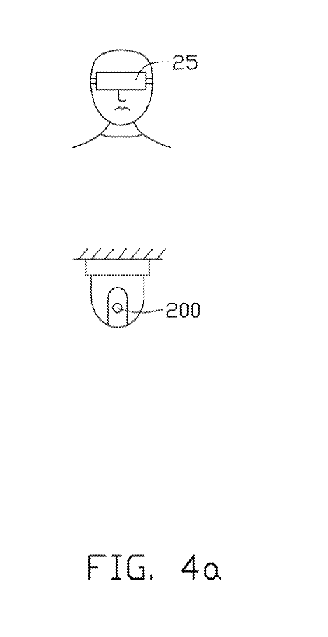

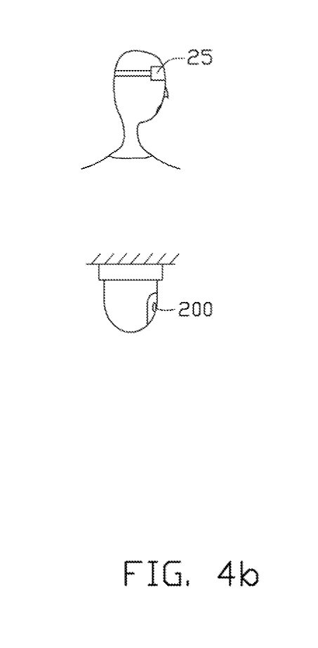

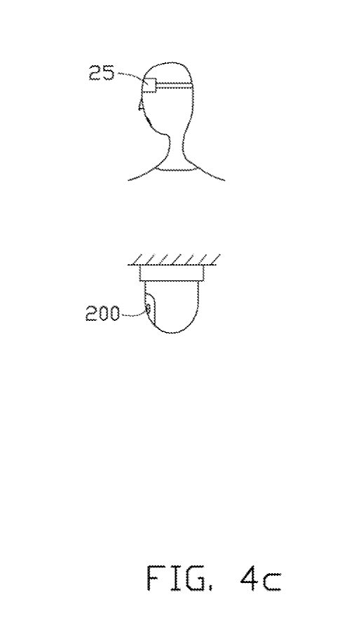

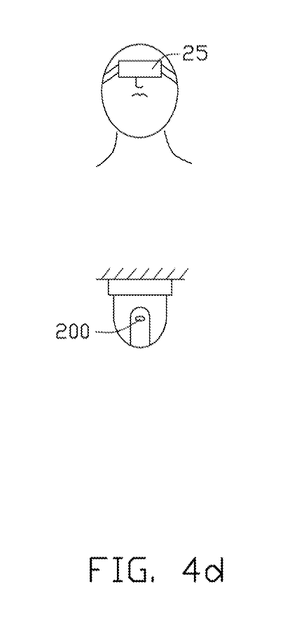

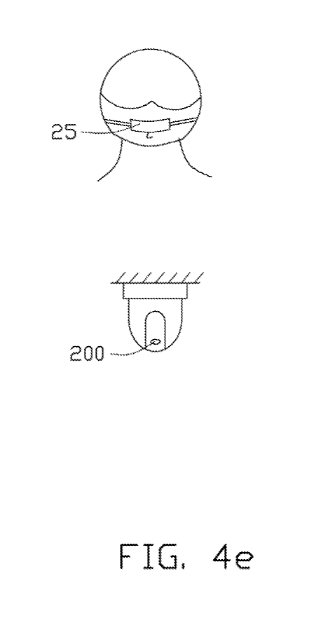

Referring to FIG. 4a, when the user wears the control glasses 25 and does not move his/her head, the displacement information is (0°, 0°). The processing unit 30 executes the second instruction and converts the displacement information (0°, 0°) to a control signal. The drive unit 220 receives the control signal via the antenna 210 and the network unit 40. The first rotating driver 222 and the second rotating driver 224 remain inactive.

Referring to FIG. 4b, when the user wears the control glasses 25 and turns his/her head left 45 degrees, the displacement information is (−45°, 0°). The processing unit 30 executes the second instruction and converts the displacement information (−45°, 0°) to a control signal. The drive unit 220 receives the control signal via the antenna 210 and the network unit 40. The second rotating driver 224 keeps still relative to the first rotating driver 222 and the first rotating driver 222 rotates around the vertical axis to turn the camera 200 left 45 degrees.

Referring to FIG. 4c, when the user wears the control glasses 25 and turns his/her head right 45 degrees, the displacement information is (+45°, 0°). The processing unit 30 executes the second instruction and converts the displacement information (+45°, 0°) to a control signal. The drive unit 220 receives the control signal via the antenna 210 and the network unit 40. The second rotating driver 224 keeps still relative to the first rotating driver 222 and the first rotating driver 222 rotates around the vertical axis to turn the camera 200 right 45 degrees.

Referring to FIG. 4d, when the user wears the control glass 25 and tilts his/her head up 45 degrees, the displacement information is (0°, +45°). The processing unit 30 executes the second instruction and converts the displacement information (0°, +45°) to a control signal. The drive unit 220 receives the control signal via the antenna 210 and the network unit 40. The first rotating driver 222 keeps still and the second rotating driver 224 rotates about the horizontal axis to tilt the camera 200 up 45 degrees.

Referring to FIG. 4e, when the user wears the control glasses 25 and tilts his/her head down 45 degrees, the displacement information is (0°, −45°). The processing unit 30 executes the second instruction and converts the displacement information (0°, −45°) to a control signal. The drive unit 220 receives the control signal via the antenna 210 and the network unit 40. The first rotating driver 222 keeps still and the second rotating driver 224 rotates about the horizontal axis to tilt the camera 200 down 45 degrees.

In another embodiment, the gravitational sensor 10 may detect other motions of the head of the user, such as moving forward or backward. The gravitational sensor 10 sends a corresponding electronic signal to the processing unit 30. The processing unit 30 executes a first instruction and converts the electronic signal to displacement information about a distance of moving forward or backward. The processing unit 30 executes a second instruction and converts the displacement information to a control signal. For example, when the head of the user moves forward for 10 centimeters (cm), the control signal controls the lens of the camera 200 to elongate for 1 cm.

The camera 200 receives the control signal via the antenna 210 and the network unit 40. The camera 200 controls its lens to flex. Therefore, the focus of the camera 200 can be changed.

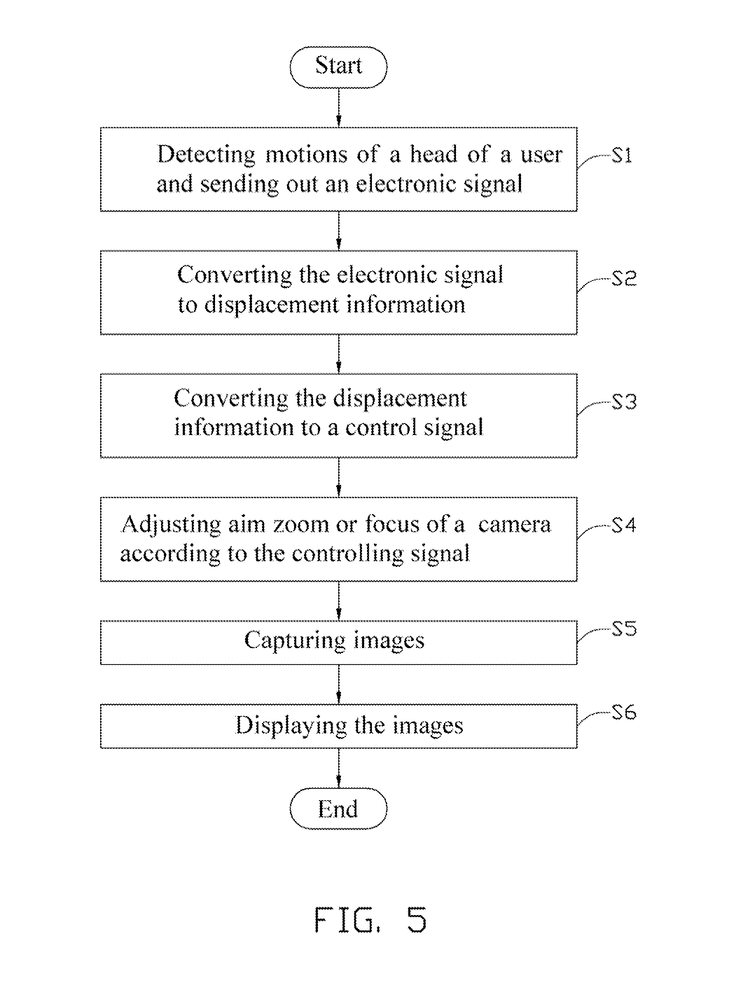

Referring to FIG. 5, an embodiment of a camera adjusting method includes the following steps.

In step 1, detecting motions of a head of a user that wears the control glasses 25 of the camera adjusting system, and sending out an electronic signal.

In step 2, converting the electronic signal to displacement information.

In step 3, converting the displacement information to a control signal.

In step 4, adjusting aim and/or focus of the camera 200 according to the control signal.

In step 5, capturing images by the camera 200.

In step 6, displaying the images captured by the camera 200.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A camera adjusting system for adjusting an angle or/and a focus of a camera, comprising:
a control headgear to be worn by a user;
a sensor mounted to the control headgear, to detect motions of the head of the user and send out an electronic signal;
a storing unit comprising a calculating module and a controlling module, wherein the calculating module stores a first instruction and the controlling module stores a second instruction;
a processing unit, wherein the processing unit executes the first instruction to convert the electronic signal to displacement information and executes the second instruction to convert the displacement information to a control signal;
a network unit connected to the processing unit, to receive the control signal;
a signal sending and receiving unit, to communicate with the network unit, to receive the control signal; and
a drive unit connected to the signal sending and receiving unit, to receive the control signal, thereby to rotate according to the control signal, thus adjusting the angle or/and focus of the camera.

2. The camera adjusting system of claim 1, wherein the sensor is a gravitational sensor.

3. The camera adjusting system of claim 1, wherein the control headgear may be control glasses, the sensor is set on a rim of the control glasses and exposed from the rim.

4. The camera adjusting system of claim 3, further comprising a display connected to the processing unit and configured as a lens and mounted in the rim alongside a lens of the control glasses, wherein the display displays images captured by the camera and transferred via the signal sending and receiving unit, the network unit, and the processing unit.

5. The camera adjusting system of claim 1, wherein the signal sending and receiving unit is an antenna.

6. The camera adjusting system of claim 1, further comprising a base, the signal sending and receiving unit is accommodated in the base.

7. The camera adjusting system of claim 6, wherein the drive unit includes a first rotating driver rotatably mounted to the base and a second rotating driver rotatably mounted to the first rotating driver, the camera is mounted to the second rotating driver, wherein a first axis that the first rotating driver rotates about is perpendicular to a second axis that the second rotating driver rotates about.

8. The camera adjusting system of claim 7, wherein the first axis is vertical, and the second axis is horizontal.

9. A camera adjusting method for adjusting an angle or/and a focus of a camera, the method comprising:
detecting motions of a head of a user and sending out an electronic signal;
converting the electronic signal to displacement information;
converting the displacement information to a control signal;
adjusting aim and/or focus of the camera according to the control signal.

10. The camera adjusting method of claim 9, further comprising:
capturing images by the camera; and
displaying the images.
